(19) United States
(12) Patent Application Publication
(10) Pub. No.: US 2008/0103795 A1
(43) Pub. Date: May 1, 2008

(54) LIGHTWEIGHT AND HEAVYWEIGHT INTERFACES TO FEDERATED ADVERTISING MARKETPLACE

(75) Inventors: David Jakubowski, Kirkland, WA (US); Yosha R. Ulrich-Sturmat, Kirkland, WA (US); Brian Burdick, Bellevue, WA (US); Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Richard Liam Pelly, Seattle, WA (US); Christopher Andrew Daniels, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/762,243

(22) Filed: Jun. 13, 2007

Related U.S. Application Data
(60) Provisional application No. 60/862,969, filed on Oct. 25, 2006.

(51) Int. Cl. G06Q 10/00; G06F 17/30

(52) U.S. Cl. 705/1

(57) ABSTRACT

For a multi-party advertising exchange including advertising and publishing entities from different advertising networks, the invention provides architectures for an online advertising marketplace that range from lightweight to heavyweight implementations. A lightweight client side implementation of an interface includes centralized processing and storage of federated advertising marketplace data by centralized servers or services. A heavyweight client side implementation of an interface for advertising entities includes providing a peer instance of a federated advertising exchange application or set of processes is provided to each advertising entity as an interface for advertising entities where processing and storage are performed locally to each peer instance. Distributed advertising data can be replicated or synchronized with other peer instances.

### CROSS REFERENCE TO RELATED APPLICATIONS

This application claims priority to U.S. Patent Application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

For online advertising architectures and environments, the subject disclosure relates to advertising architectures ranging from lightweight to heavyweight as infrastructure for participants to interact with a federated advertising marketplace including participants from disparate advertising networks.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Accordingly, improved systems and methods are desired for publishers and advertisers to interface with a federated marketplace for advertising transactions that are not subject to the constraints of participation in a single, proprietary advertising network. More specifically, an additional layer is desirable that would expose a federated marketplace to advertisers independent of differing standards of individual advertising networks whereby the individual participants interact with the federated marketplace, and the layer customizes such experience according to the individual's biases. Such a system would drive pricing of the overall advertising marketplace closer to expected value returned based on aggregate supply and demand principles, without being held hostage to any penalties or restrictions imposed by any one proprietary or closed network.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities from different advertising networks, the invention provides architectures for an online advertising marketplace that range from lightweight to heavyweight implementations. In various embodiments, lightweight client side implementations of an interface for advertising entities include centralized processing and storage of the federated advertising marketplace by servers or services. In heavyweight client side implementations of an interface for advertising entities, a peer instance of a federated advertising exchange application or set of processes is provided to each advertising entity as an interface for advertising entities where processing and storage are performed locally to each peer instance. By replicating or synchronizing data from each instance to other peer instances, advertising marketplace data is dynamically aggregated and updated to form a virtual federated marketplace for advertising entities across disparate advertising networks. Hybrid solutions are also possible as described in more detail below.

In one embodiment, for transactions in an advertising exchange, the invention provides a publisher instance of an advertising console for interfacing with a federated advertising marketplace and used by a publisher broker representing publishers to specify asks for advertisement space via the publisher instance. The invention also provides an advertiser instance of an advertising console for interfacing with the federated advertising marketplace and used by an advertiser broker representing advertisers managing bids for the advertisement space via the advertiser instance. Storage can be centralized or distributed storage for storing information about at least one transaction for the advertisement space conducted in the federated advertising marketplace via the publisher instance and advertiser instance. Where distributed, the data is shared, replicated or synchronized to other instances.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the lightweight to heavyweight implementations for federated online advertising architectures in accordance with the present invention are further described with reference to the accompanying drawings in which:

FIG. 1 is a block diagram of a federated advertising marketplace in accordance with architectures of the invention;

FIG. 2 is a block diagram of a federated advertising marketplace according to a centralized server architecture in accordance with the invention;

FIG. 3 is a block diagram of a federated advertising marketplace according to a distributed processing architecture in accordance with the invention;

FIG. 4 is a block diagram of a federated advertising marketplace according to a centralized server and storage architecture in accordance with the invention;

FIG. 5A is a block diagram of a federated advertising marketplace according to a distributed processing and storage architecture in accordance with the invention;

FIG. 5B is a block diagram of sharing data among nodes of a federated marketplace according to a distributed processing and storage architecture in accordance with the invention;

FIG. 6 is a block diagram of a federated advertising marketplace according to a hybrid processing and storage architecture in accordance with the invention;

FIG. 7 is a block diagram of a federated advertising marketplace according to a centralized server and storage architecture in accordance with the invention;

FIG. 8 is a block diagram of a federated advertising marketplace according to a distributed processing and storage architecture in accordance with the invention;

FIG. 9 is a generalized architecture for conducting on-line web advertising in a federated advertising marketplace according to any of the architectures of the invention;

FIGS. 10A and 10B are flow diagrams showing processes for participating in a federated advertising marketplace according to a centralized on-line advertising exchange architecture or distributed on-line advertising exchange architecture in accordance with the invention, respectively;

FIG. 11 is a block diagram of a computing system environment suitable for use in implementing the present invention;

FIG. 12 illustrates a distributed architecture for online advertising, according to embodiments of the present invention;

FIG. 13 illustrates one example of the flow of data within an exemplary non-limiting architecture according to embodiments of the present invention;

FIG. 14 illustrates a flowchart of the operation of an exchange, according to exemplary, non-limiting embodiments of the present invention; and

FIG. 15 illustrates a flowchart of the operation of user or a user data broker to provide potentially valuable information according to embodiments of the present invention.

### DETAILED DESCRIPTION

### Overview

In various non-limiting embodiments, the invention is described in the context of federated architectures for online advertising, i.e., a market mechanism that manages the exchange of advertising goods among multiple participants on the advertising and/or publishing side, and across disparate advertising networks that today are exclusive of one another as described in the background. In part consideration of the limitations on existing architectures described in the background, the invention enables differing implementations of such federated architectures ranging from lightweight to heavyweight processing and storage models associated with marketplace transactions.

An advertising system to facilitate trading of advertising, such as a federated advertising exchange, is provided as a federated advertising layer for disparate advertising networks. The system may include (A) a publisher broker to represent publishers that determines an ask for an advertisement space on the publishers' inventory, such as a webpage, (B) an advertiser broker to represent advertisers that manages the advertisers' bids for the advertisement space to display the advertisers' advertisements and (C) an exchange to facilitate a transaction for the advertisement space between the publisher broker and the advertiser broker.

The exchange can be implemented as centralized server(s) or services and storage with which the participating advertising entities interface, or according to a local processing, storage and replication model in which a set of cooperating local applications or processes collectively form a dynamic federated marketplace. As a common layer for interaction across all participants, problems with incompatibility of different advertising networks are avoided, and as the number of advertising entities becomes large, the diversified base of different advertising networks helps drive prices closer to expected value for better marketplace certainty for all participants.

The invention includes a system to facilitate trading of advertising, comprising participating sites each implementing and customizing a peer instance of an advertising platform and communications APIs for federating knowledge across the participating sites.

Accordingly, in one aspect, the invention facilitates trading of advertising including an online advertising exchange for trading advertising and inventory across disparate advertising networks and participating sites communicatively coupled to the online advertising exchange, each including an advertising console for participating sites to interact with an auction process conducted by the online advertising exchange.

Optionally, the exchange is implemented as a server based solution or each implementing site is given a peer instance of an advertising platform, such as Adcenter, which is implemented/customized by the site. Then, each instance of Adcenter, while operating locally with respect to a particular site, such as eBay, communicates together to provide the information exchange required to federate the advertising knowledge across all of the implementing Adcenters. An advertising console can thus be provided as a lightweight option for exchange participants as an operating layer above an auction. Logic associated with an online advertising exchange implementation can be implemented in a distributed client side application.

The ideas of the online advertising exchange of the invention can also be extended to federate auctions on publisher web sites, i.e., provide an off the shelf experience that enables “eBay” style product auctions for small folks. In this regard, any local provider could host a niche style auction, which may be of interest to particular advertisers in the niche.

As described herein, various embodiments of the invention can be implemented in a peer to peer architecture, which includes a local client side solution for realizing OLX. In such an embodiment, the online exchange is, for example, implemented as an advertising platform, such as Microsoft's Adcenter or similar product. In such an embodiment, each implementing site is given a peer instance of an advertising platform, such as Adcenter, which is implemented by the site. Then, each instance of Adcenter, while operating locally with respect to a particular site, such as eBay, communicates together to provide the information exchange required to federate the advertising knowledge across all of the implementing Adcenters.

With a peer instance of Adcenter, each site specifies rules for local advertising, For instance, eBay might specify that they want $2/transaction, will only pay for actual sales, etc., including a tool for automatically generating text creative for describing advertising at the site. As a result, each implementing site can hold eBay style auctions for advertising at the local site in a way that conforms to rules for advertising at the site. Without a centralized OLX, the OLX processing capabilities of the invention are pushed down to the implementing peers in the system. For instance, information about ads as well as inventory can be exchanged via one or more communications networks. The federated approach of the online advertising exchange is thus preserved.

Optionally, with respect to a peer instance advertising product that endpoints, or participants can implement, companies can implement a company centric Adcenter. For instance, eBay, for example, can expose its APIs, XML, etc. for certain kinds of traffic to the product. Not only can advertisements be placed into the product, but the version of Adcenter can be customized for eBay. For instance, eBay can personalize the Adcenter, e.g., Adcenter may follow the same workflow as before, but might embed additional account information for a user's account as part of the eBay centric Adcenter.

In this regard, the invention provides tools for customizing an Adcenter instance. Customization optionally includes creative text styling, making changes to an ordering mechanism to more accurately reflect the nature of the business transaction, applying system wide biases (e.g., Jaguar means sports team, not car), demoting or denying some listings as inappropriate (e.g., gambling/pornography bad), promotion of a defined vertical (e.g., electrical appliances), filter competitors, enable advertiser subsidy, etc.

The invention also optionally includes reporting tools for reporting from the product to the online advertising exchange. As such, performance statistics can be compared between exchange and performance of the peer instance. This comparison enables dynamic pricing knowledge that can be powerful in understanding the effectiveness or ROI on an advertisement. For instance, Yahoo may wish to display their own advertising on their own inventory (e.g., Yahoo personals on the home page), referred to as house advertisements. With such performance comparisons and due to the global advertising liquidity of the exchange, Yahoo can receive immediate feedback and become confident that the house ad pays for itself despite the opportunity cost of displaying a third party advertisement.

In other embodiments, an architecture for a federated advertising marketplace can be an independent or shared gateway in accordance with the invention. The gateway can be run as multiple units. Shared Gateway Internals may include (1) ad de-duping functionality which can also be done on the publisher side, but can be performed more consistently at a shared gateway, (2) editorial functionality giving consistency of quality, trademark, sensitivity, and adult standards, e.g., some rules/logic can be embedded within the gateway, (3) billing functionality giving different participants such as Yahoo! or Microsoft to “buy” impressions or clicks from one another. Each option may have different requirements, e.g., different aggregation times, (4) targeting functionality that enables a participant to target across the federated network while preserving user privacy, (5) result blending and/or ordering functionality where each side may want something different than revenue ordering, i.e., having some level of transparency of the other's objectives or utility functions allows greater collaboration in the marketplace, (6) performance review capability on a per participant, or per transaction basis, (or 7) any other requirement for a shared gateway that would be useful to participants in the federated marketplace, e.g., logging, syndication, ordering, etc.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Lightweight to Heavyweight Implementations of a Federated Advertising Exchange

As mentioned in the background, currently, advertising networks follow a closed, proprietary model that places inherent limits on advertising market forces that would otherwise occur. Being required to commit to a single advertising model, for instance, clearly limits purchasing choice to the extent that any other marketplaces or advertising networks are otherwise available.

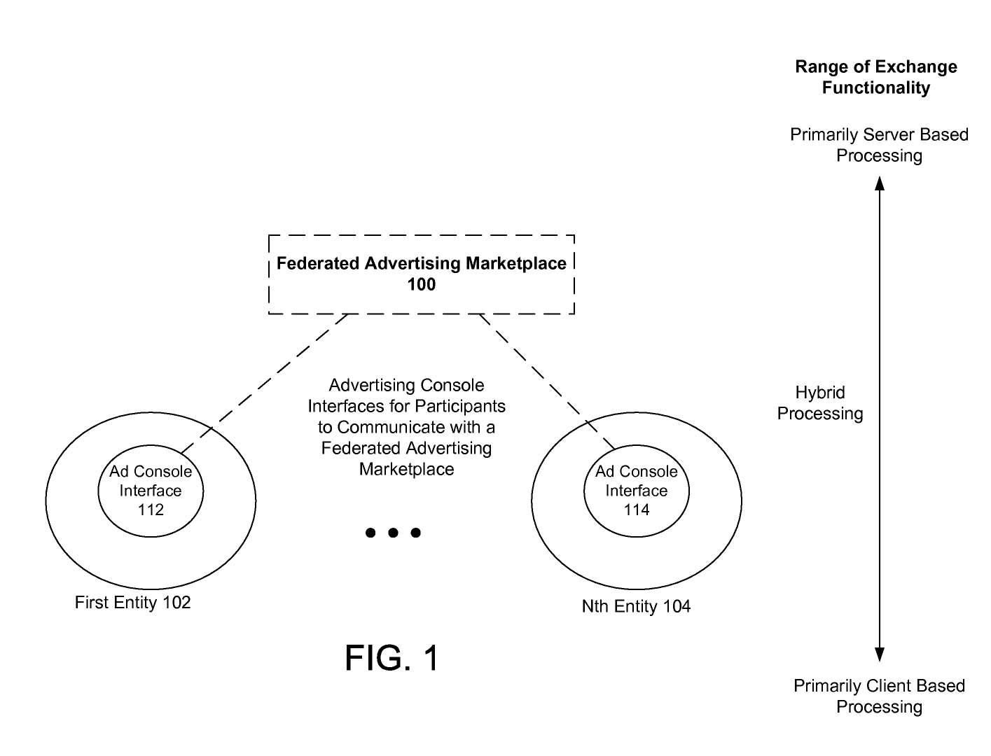

Accordingly, the invention provides several different architectures for achieving the goals of a federated advertising system in which any advertiser or publisher may affiliate, either individually, or through broker entities. As shown in FIG. 1, the architectures of the invention include the ability for any number of advertising entities from first entity 102 to Nth entity 104 to participate in a federated advertising marketplace 100 that accommodates disparate advertising networks. In one aspect, the invention normalizes aspects of disparate advertising networks to a common vocabulary, e.g., normalizes cost per acquisition bids versus cost per impression bids to a common currency, within advertising marketplace 100 so that direct comparisons can be made among deals from disparate advertising networks. In accordance with the invention, from the perspective of a participant in the federated advertising marketplace, the participant is provided with an advertising console interface that allows the participant to interact with the federated advertising marketplace. For instance, as shown, first entity 102 is given an ad console interface 112 and so on down to the Nth entity 104 given an ad console interface 114.

For example, first entity 102 might be a publisher broker representing a variety of publishers in which case the publisher broker would use interface 112 to place asks for inventory on behalf of its publishers, to track the performance of transactions conducted in marketplace 100 on behalf of its publishers, or otherwise to satisfy the objectives of its publishing base.

Similarly, any other entity is provided with an interface to interact with the federated marketplace 100. For instance, as shown, Nth entity 104 includes interface 114. Nth entity 102 might be an advertiser broker representing a variety of advertisers in which case the advertiser broker would use interface 114 to place bids for advertising on behalf of its advertisers, to track the performance of transactions conducted in marketplace 100 on behalf of its publishers, or otherwise to satisfy the objectives of its advertising base.

In accordance with various architectures described in more detail below, interface 112 or 114 may comprise any one or more of an application or process executing on a device, an interface to a Web service, an interface to a Web server such as a browser, an interface to storage, etc., any one or more of which enables the participant to interact with the federated marketplace 100. For instance, a participant may wish to view the participant's transaction history or performance, to transact in federated marketplace 100, to set up, configure or make changes to the participant's profile for default interaction with federated marketplace 100, to change a participation goal, to upload advertising or inventory information, or otherwise interact with marketplace 100.

Thus, FIG. 1 illustrates how interfaces 112 and 114 provided to each participant enable a federated advertising marketplace where participants from disparate advertising networks can congregate for more efficient transactions with fewer marketplace boundaries that are imposed by proprietary advertising networks. On the right hand side of FIG. 1 is an illustration of a range of architectures that can be implemented to achieve the above-described goal of giving each participant an interface to a federated marketplace 100. On the one hand, one could implement primarily server based processing where centralized servers and data storage are the primary components for achieving the functionality of the marketplace 100. On the other hand is a primarily client based processing and storage model where the devices used by the various entities including the interfaces to the marketplace 100 collectively provide the functionality of the marketplace 100 by sharing processing and data across the devices.

Moreover, architectures for processing and storage need not go hand and hand and can be implemented differently. For instance, processing could mainly be performed by Web servers whereas the devices of the N entities 102 to 104 could implement distributed storage for marketplace data. Or alternatively, each of the devices of the N entities 102 to 104 could individually provide distributed processing for engaging in marketplace 100, which collectively enables the functionality of the entire marketplace 100, however, storage for each of the devices could be implemented according to network storage and logging model (e.g., a centralized data store) so that each of the entities 102 to 104 has access to and updates a common storage base. Where functionality, such as processing or storage, is shared between devices of entities 102 to 104 and a Web server, such architecture is considered a hybrid architecture.

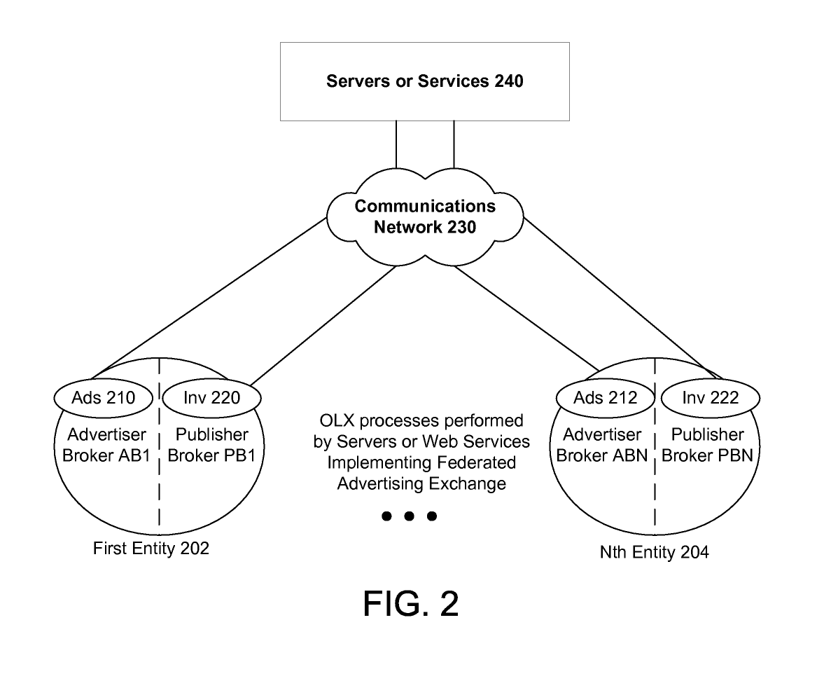

FIG. 2 is a high level diagram of a first architecture that may be implemented for a federated advertising exchange provided in accordance with the invention. Like FIG. 1, a set of N entities, first entity 202 to Nth entity 204, participate in a federated marketplace for disparate advertising networks through communications network(s) 230. Entities may be from the publishing or advertising side, either interacting directly with the marketplace or through a broker. Optionally, other participants (not shown) may also add value to the exchange by providing information of value helping to make for a more informed marketplace. In the embodiment of FIG. 2, a set of servers and/or services 240 are provided for implementing the functionality of the federated marketplace.

As shown, an entity such as first entity 202 may include both an advertiser broker AB1 and a publisher broker PB1, each of which may have an interface 210 and 220, respectively, for participating in the federated marketplace. Similarly, Nth entity 204 may include an advertiser broker ABN and a publisher broker PBN having interfaces 212 and 222, respectively.

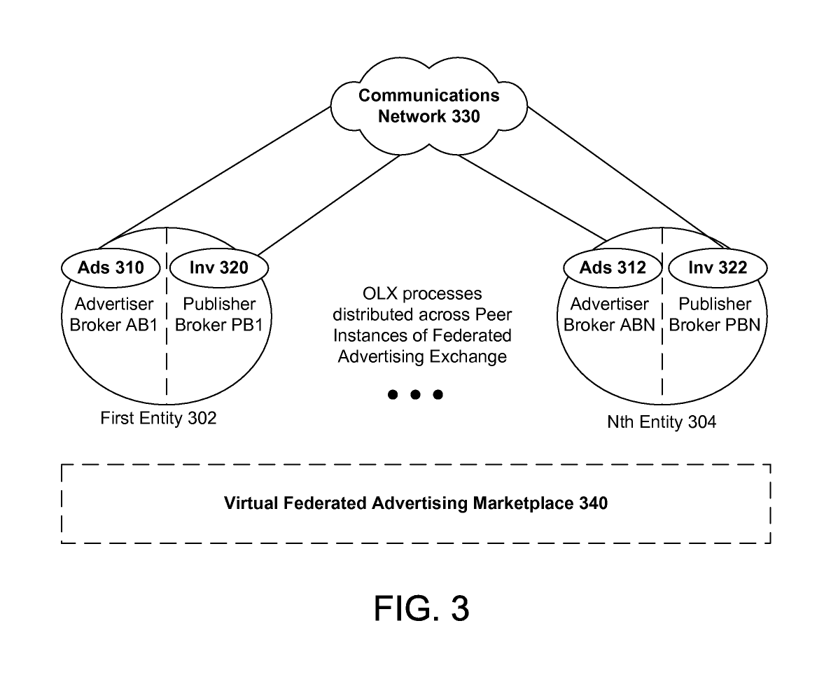

FIG. 3 illustrates a distributed client based implementation provided in accordance with the invention. In FIG. 3, instead of performing the functionality associated with federated marketplace via centralized servers, instead a peer-to-peer distributed model is implemented whereby each entity, such as first entity 302 to Nth entity 304, is provided with a peer instance of an application or process that interacts with other peer instances to collectively provide a virtual federated advertising marketplace 340 that exists across the devices. In such case, advertiser instances 310 to 312 are provided to the N entities, such as advertiser brokers AB1 to ABN, that may be participating in marketplace 340 at any given time and similarly, publisher instances 320 to 322 can be provided to the N entities, such as publisher brokers PB1 to PBN, though as mentioned, individual participants need not interact through a broker. In contrast to FIG. 2 where the marketplace can be conceptually visualized as functionality provided from a common or centralized location, the marketplace of the embodiment of FIG. 3 is virtualized across all of the participant's devices via their respective instances implementing peer-to-peer exchanges of data and sharing of processing by communicating via network(s) 330. FIGS. 2 and 3 thus illustrate centralized versus shared processing architectures, respectively, for implementing a federated advertising marketplace in accordance with the invention.

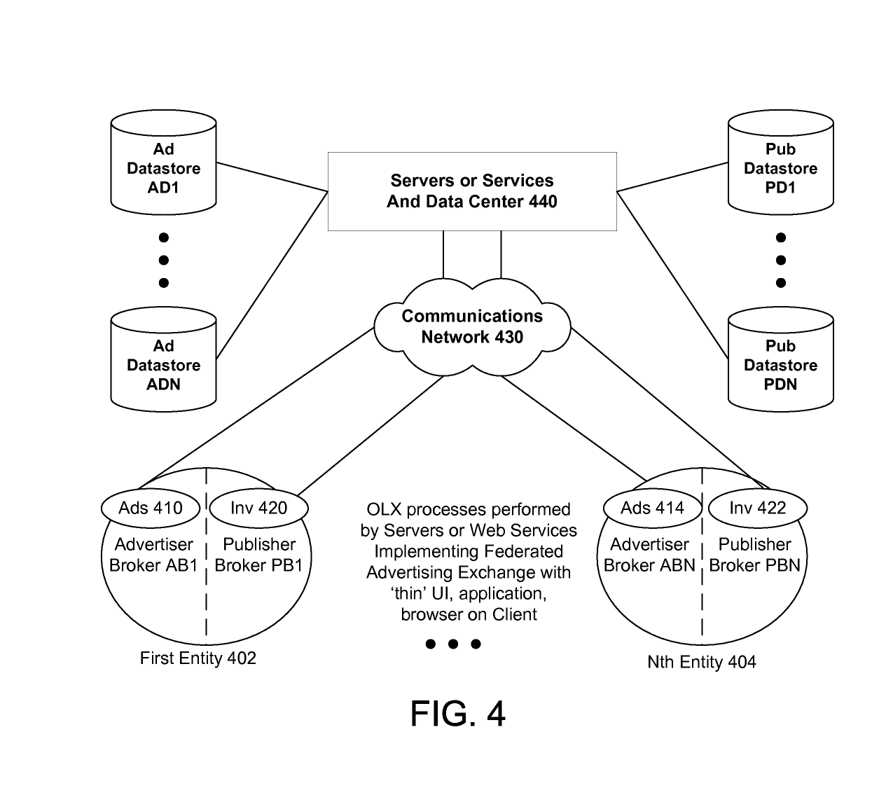

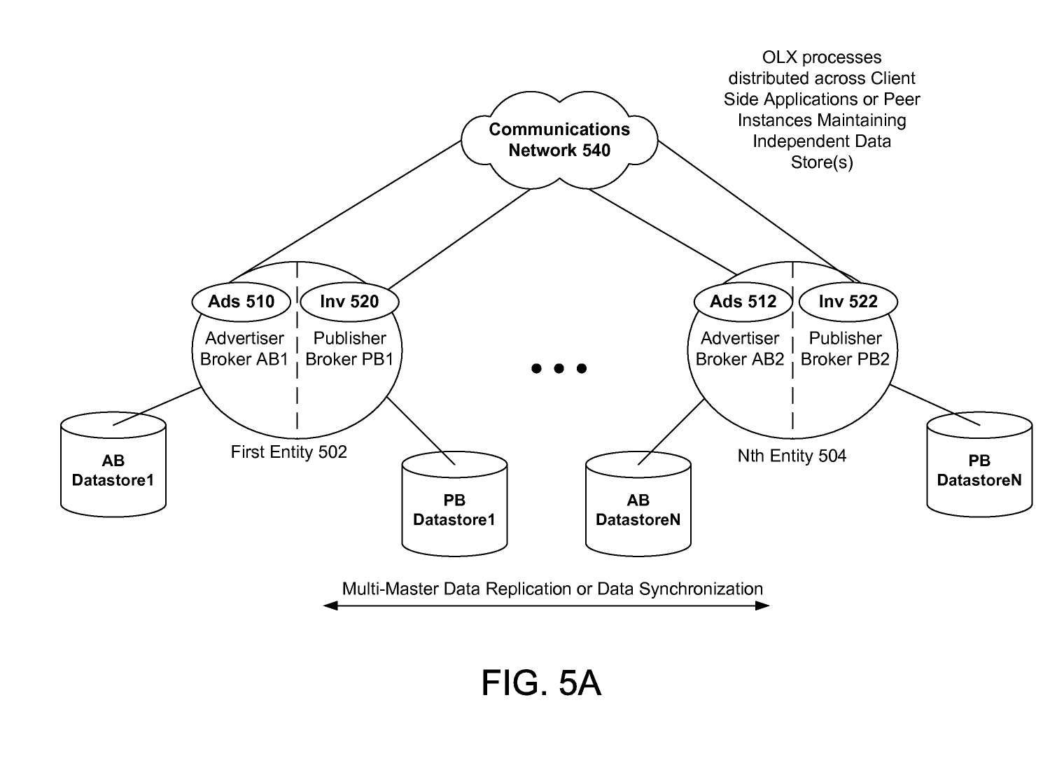

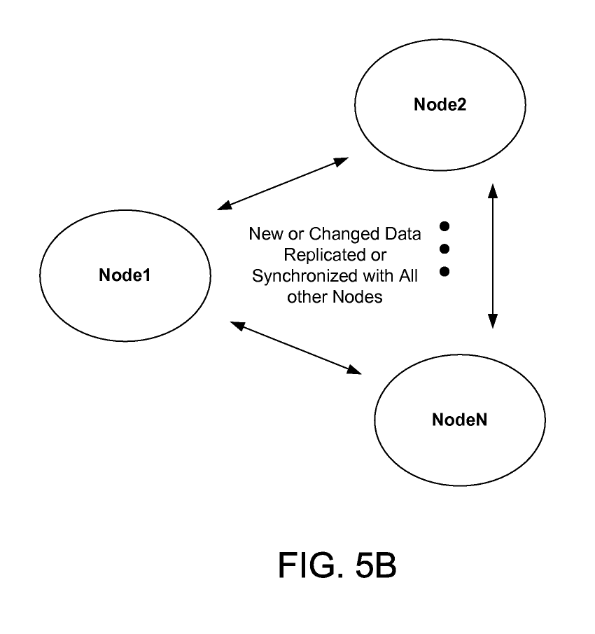

FIGS. 4 and 5A illustrate that storage for the federated advertising marketplace may also be implemented via server side and client side solutions, respectively. For instance, a set of Ad data stores AD1 to ADN can be used to store information about transactions from the advertising side and a set of Publisher data stores PD1 to PDN can be used to store information about transactions from the publishing side. Similar to FIG. 2, a set of servers 440 can maintain the data in the data stores and perform processing associated with the marketplace, such that participants 402 to 404 can interact with the federated marketplace via interfaces 410, 420, 412, 422, etc. In such embodiment, the interfaces 410, 420, 412, 422, etc. provided to participants may be provided with thin client functionality, e.g., a user interface, or a browser, to input and view data to and from the marketplace via networks 430.

FIG. 5A in turn illustrates a peer instance implementation of storage for a federated marketplace in accordance with the invention. In FIG. 5A, each entity 502 to 504 is provided with peer instances of the interfaces 510, 520, 512, 522, etc. used to communicate with one another to collectively form a federated marketplace via networks 540, however, rather than communicate with a centralized set of data stores via a server as described in FIG. 4, each entity 502 to 504 maintains its own datastore, such as AB datastore1 and/or PB datastore1 to AB datastoreN and/or PB datastoreN. The devices of each of the entities 502 to 504 then replicate or synchronize their data to one another, either as part of a push model whenever changes occur, or as part of a request model for desired data, so that marketplace is aggregated for efficient advertising transactions in the federated marketplace.

There are a myriad of ways to replicate or synchronize data among a set of nodes, however, none that have been applied to the replication or synchronization of advertising data across participants of disparate advertising networks to achieve a federated marketplace. This is illustrated conceptually illustrated in FIG. 5B. As shown, a set of nodes Node1, Node2, . . . , NodeN each participate in the federated marketplace via their respective interface instances, however, whenever new or changed data becomes present at a node, the invention includes the ability to replicate or synchronize data with any of the other nodes in order to aggregate and compare transaction data across different participant experiences. The entire advertising community overall benefits from such sharing of data, making individual participants smarter, and the overall marketplace more efficient, driving pricing closer to expected value for all participants.

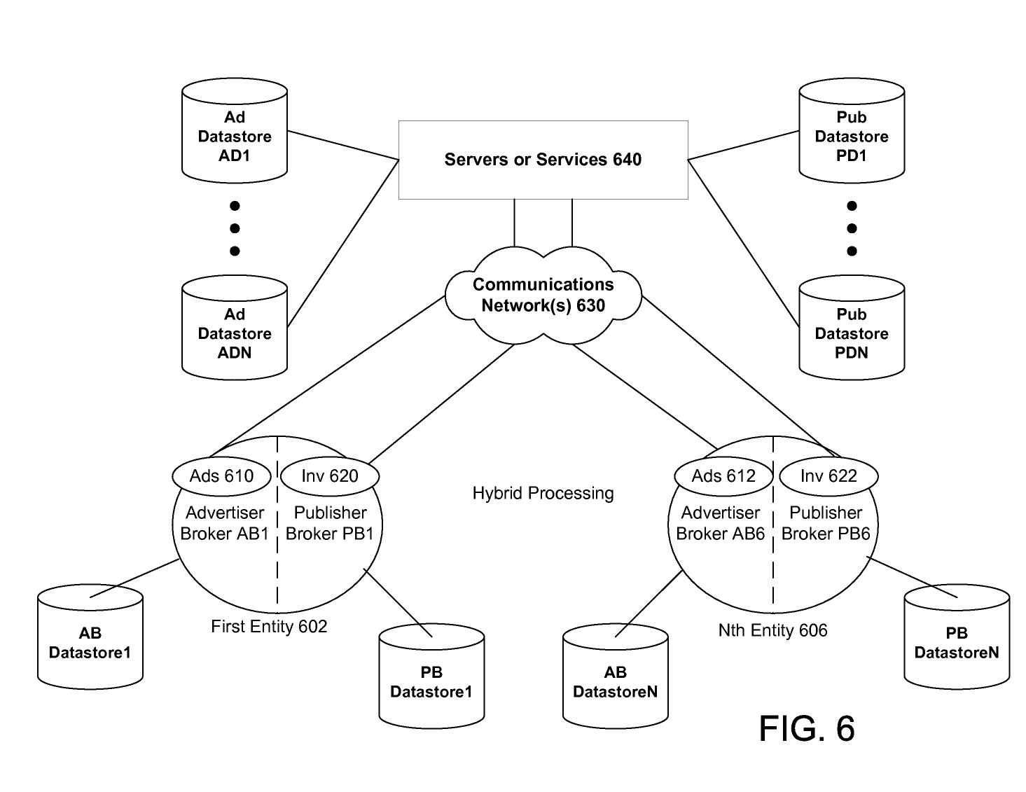

Thus, both processing and/or storage include server side and client side solutions according to the various architectures of the present invention. In addition, as shown in FIG. 6, such models can co-exist according to varying degrees of a hybrid model in which processing is shared between server and client. In FIG. 6, as with other embodiments, each entity 602 to 604 is provided with interfaces 610, 620, 612, 622, etc. used to communicate with a federated marketplace via networks 630. In the hybrid model, each entity 602 to 604 can interact with data stores AD1 to ADN and/or data stores PD1 to PDN via servers 640 and maintain AB datastore1 and/or PB datastore1 to AB datastoreN and/or PB datastoreN. Both processing and/or storage can thus be implemented in varying degrees on the client versus server side depending on the functionality of the federated marketplace.

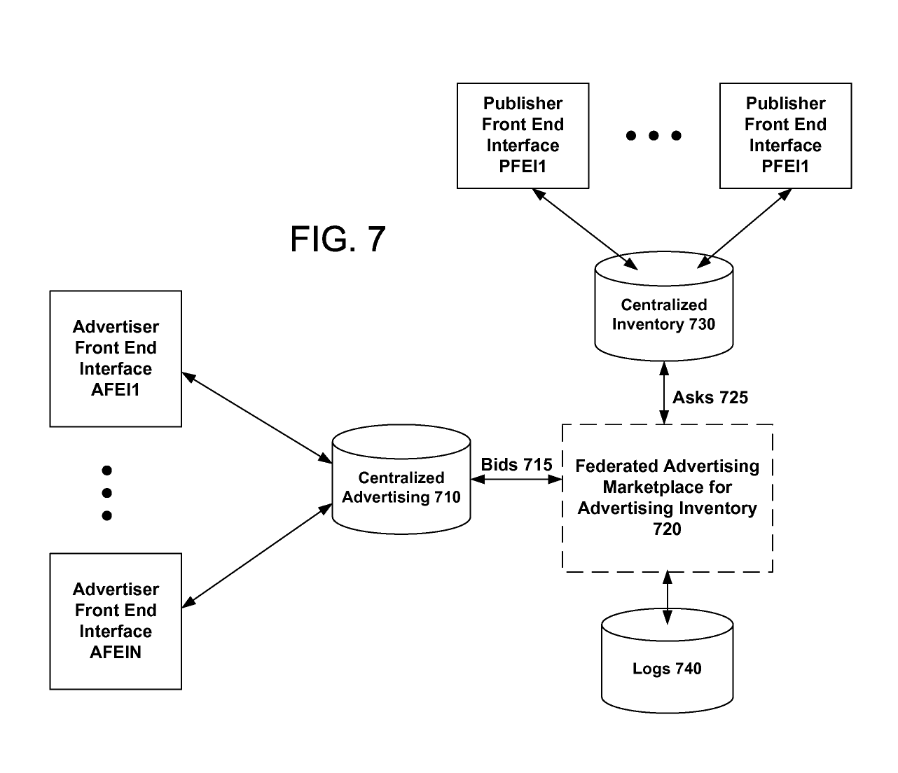

FIG. 7 is a high level block diagram of how the centralized architecture of the invention operates from the perspective of prospective advertisers. As shown, advertisers are each given an advertiser front end interface to form a set of N (N large) advertising front ends AFEI1 to AFEIN, with which the advertisers interact with a centralized advertising database 710 for storing advertising content and for making bids 715 in federated marketplace 720. Similarly, publishers are each given a publisher front end interface to form a set of N (also large, can be a different number than advertisers) publishing front end interfaces PFEI1 to PFEIN, with which the advertisers interact with a centralized publishing inventory database 730 for storing available inventory and associated asks 725 for sale in marketplace 720. Centralized logs 740 record various aspects of the marketplace 720, billing, completed transactions, performance, etc.

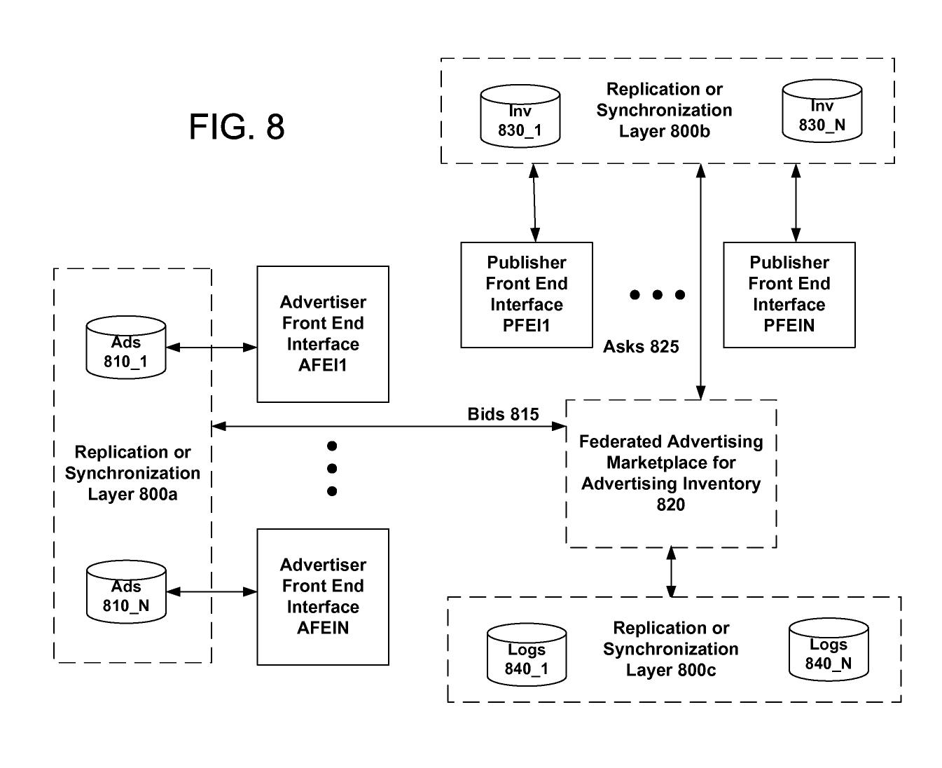

FIG. 8 is in turn a high level block diagram of an implementation of peer instances of a federated advertising exchange 820 in accordance with the invention. Conceptually, the architecture behaves similarly to the centralized architecture of FIG. 7, however, as shown, instead each advertising entity stores its own data locally for its use of advertiser front end interfaces AFEI1 to AFEIN in data stores 810_1 to 810_N. Each publishing entity stores its own data locally in connection with its use of publisher front end interfaces PFEI1 to PFEIN in data stores 830_1 to 830_N, respectively. Similarly, the logs can be individually distributed across peer instances of the front end interfaces in accordance with the invention in logs 840_1 to 840_N. As a whole, when the data is synchronized or replicated across the databases, the effect is one of aggregation equivalent to the provision of an integrated marketplace 820 for all bids 815 and asks 825.

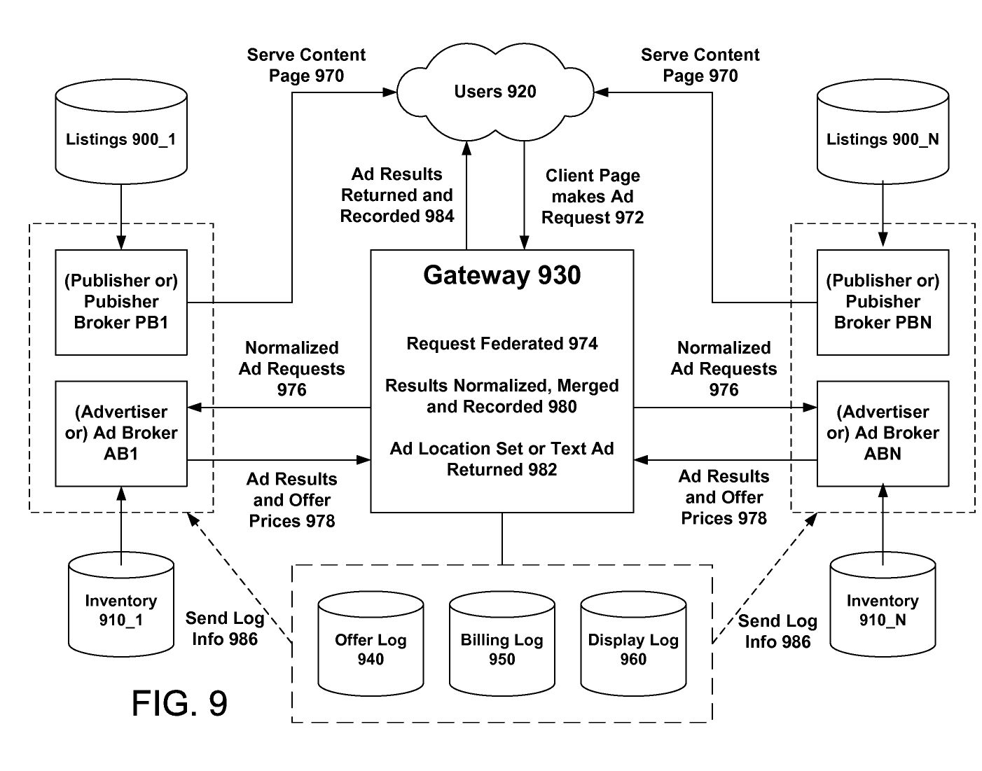

FIG. 9 illustrates a flow diagram of how participants can conduct transactions in a federated marketplace according to the various architectures of the invention. As shown, a set of advertiser brokers AB1 to ABN and publisher brokers PB1 to PBN participate in the federated advertising exchange, and whether centralized or distributed according to the above-described replication or synchronization model, inventory is stored in storage abstractions 910_1 to 910_N and listings are stored in storage abstractions 900_1 to 900_N, which form the basis for advertising gateway 930, which is a federated advertising exchange for advertising transactions. Logs 940, 950 and 960 store offers, billing records, display records, etc. associated with transactions in gateway 930.

In a web advertising embodiment, at 970, publisher brokers PB1 to PBN serve content pages to users 920. If users make a Web page ad request at 972, the request is forwarded to gateway 930, which serves to federate the requests at 974. At 976, the ad requests that have been normalized by the gateway 930 are sent to the advertiser brokers AB1 to ABN. The advertiser brokers AB1 to ABN then send ad results and offer prices to potentially match the ad requests at 978. The ad results are then normalized, merged and recorded at 980 by gateway 930. Next, based on the results, advertisement location sets or text advertising is returned at 982. The ad results are returned to users 920 and recorded at 984. The various log info stored in logs 940, 950 and 960 may be optionally sent to the participants at 986.

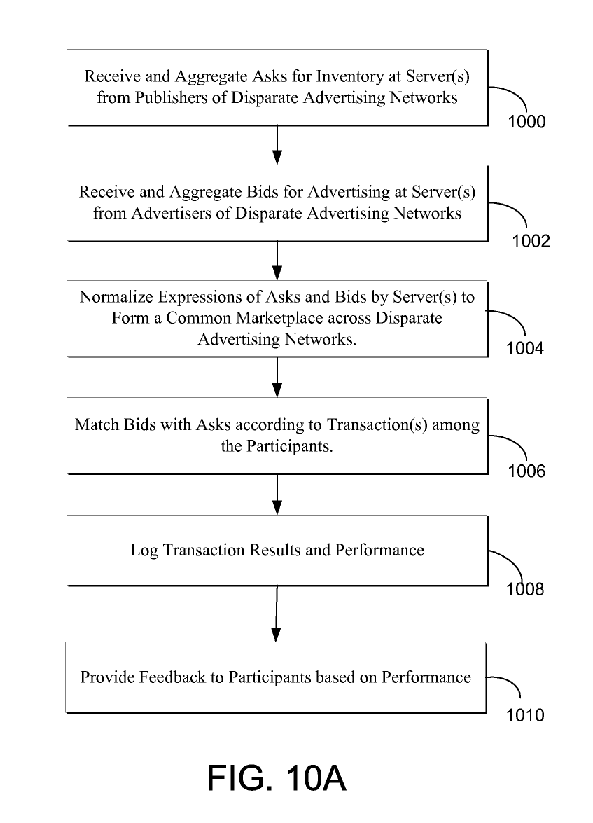

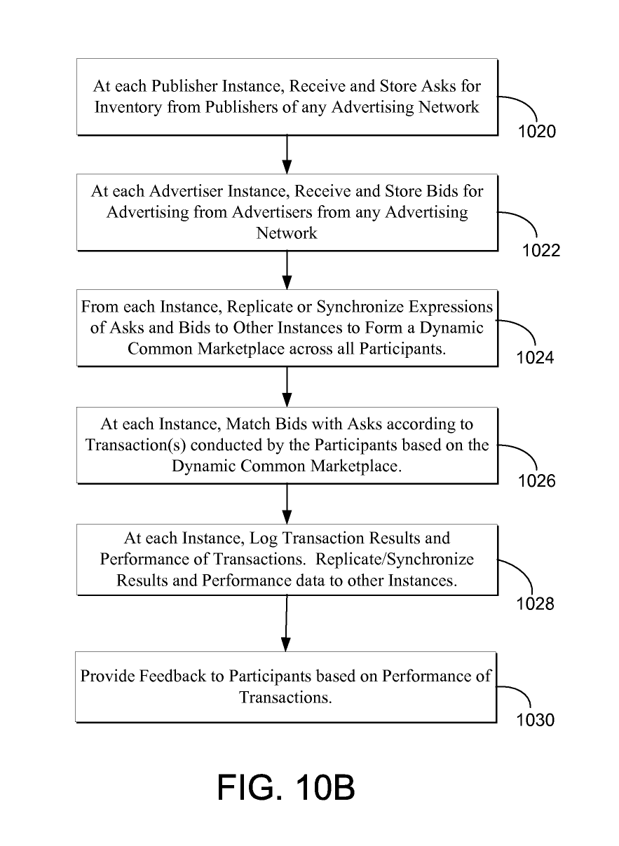

FIGS. 10A and 10B are flow diagrams illustrating exemplary processes for transacting with the federated marketplace in accordance with the different architectures of the invention. FIG. 10A illustrates a process flow where the architecture implements primarily server based functionality. At 1000, asks for inventory are received from publishers at online exchange (OLX) servers, where the publishers may be from disparate advertising networks. At 1002, bids for advertising are received from advertisers at online exchange (OLX) servers, where the advertisers may be from disparate advertising networks. At 1004, the expressions of asks and bids are normalized by the servers to form a common marketplace across disparate advertising networks. At 1006, the OLX servers match bids with asks according to various transactions conducted by the participants. Those transaction results, billing, performance, etc. are logged at 1008, and optionally, participants can receive ongoing feedback about how they are performing in the marketplace at 1010.

FIG. 10B illustrates a process flow where the architecture implements functionality of the federated marketplace via peer instances of an advertising console or interface provided to each participant. Accordingly, each publisher is provided with a publisher instance that enables a publisher at 1020 to perform all of the necessary functionality to participate in the on-line federated advertising marketplace, e.g., specify and store asks for inventory. Similarly, each advertiser is provided with an advertiser instance that enables an advertiser at 1022 to perform all of the necessary functionality to participate in the on-line federated advertising marketplace, e.g., specify and store bids for advertising. Such advertiser or publishers may be represented through a broker and may be from disparate advertising networks. Then, at 1024, each instance operates to replicate or synchronize expressions of asks and bids to other instances to form a dynamic common marketplace across all participants.

Then, at 1026, each instance matches bids with asks for potential transaction(s) in the dynamic common marketplace. At 1028, each instance may operate to log transaction results and performance data for transactions, which are replicated/synchronized to other instances. At 1030, feedback can then be provided to participants based on collective performance of transactions across the entire federated marketplace.

For a multi-party advertising exchange, including publishing entities and advertising entities from disparate advertising networks, which facilitates transactions for publishing inventory, the invention provides a value add broker to aggregate information from third parties having valuable information for input to the exchange or to perform services that are valuable to transactions in the exchange. The valuable information or services further facilitate the transactions for the publishing inventory automatically generating a benefit for the third parties providing the valuable information or services commensurate with the value provided to the transactions. Various value add broker embodiments of the invention include any entities that aggregate information or perform services that is valuable to transactions in the advertising exchange.

For instance, a value add broker may be an information broker that provides any information to the exchange that tends to increase the likelihood of transactions taking place by reducing uncertainty. For example, an audience broker provides information, such as statistical data, about audiences or users that may be implicated by one or more transactions in the exchange.

Having described various non-limiting embodiments of the architectures for participants of a federated advertising framework in accordance with the invention, exemplary non-limiting operating and advertising exchange environments in which the various embodiments may be implemented are now described.

### Exemplary Operating Environment(s)

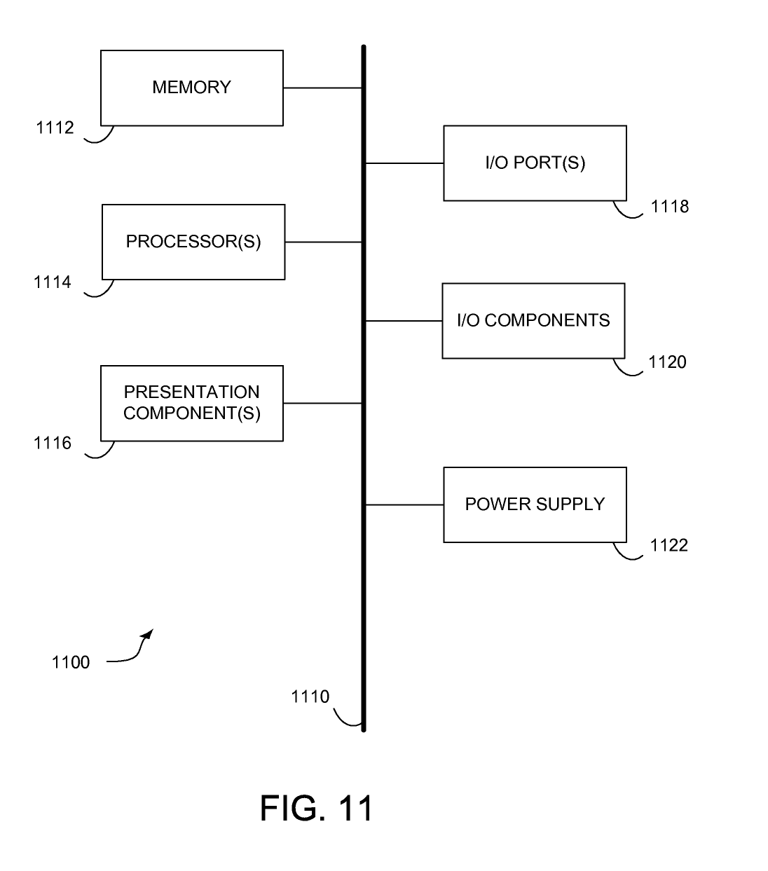

Referring initially to FIG. 11 in particular, an exemplary operating environment for implementing embodiments of the present invention is shown and designated generally as computing device 1100. Computing device 1100 is but one example of a suitable computing environment and is not intended to suggest any limitation as to the scope of use or functionality of the invention. Neither should the computing-environment 1100 be interpreted as having any dependency or requirement relating to any one or combination of components illustrated. In accordance with the invention, participants can communicate with an advertising exchange via one or more computing devices 1100, and the advertising exchange may also comprise one or more computing devices 1100, in order to carry out one or more aspects of the invention described in detail below. As described in detail above, implementations may range from lightweight to heavyweight architectures with respect to how much processing is performed at the front end interface

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 11, computing device 1100 includes a bus 1110 that directly or indirectly couples the following elements: memory 1112, one or more processors 1114, one or more presentation components 1116, input/output ports 1118, input/output components 1120, and an illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 11 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 1100.

Memory 1112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc.

### Exemplary Architecture(s) for Online Advertising

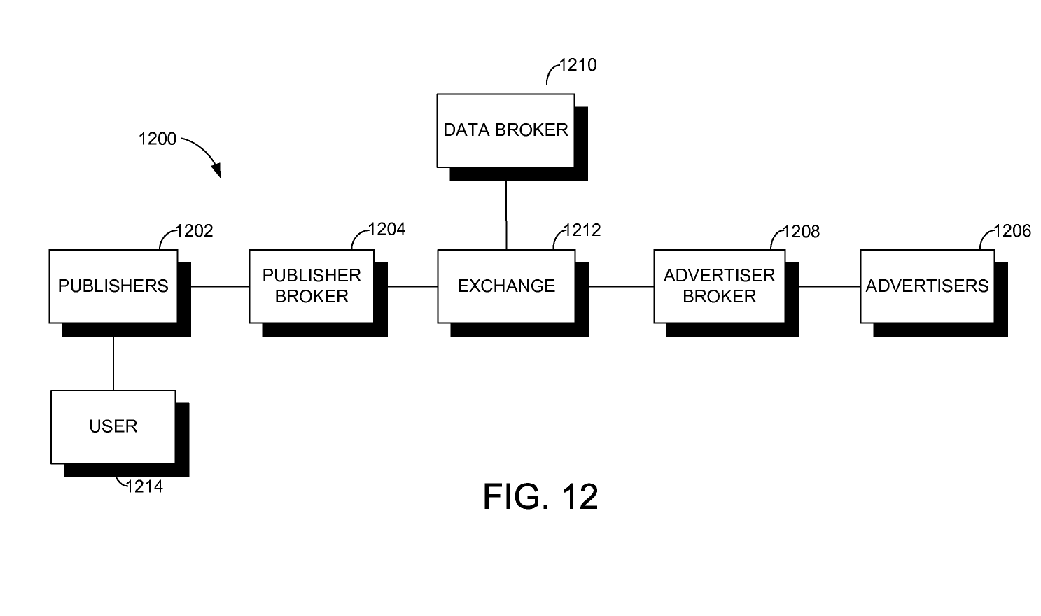

Exemplary online advertising environments for the various architectures in which the present invention may be deployed or implemented are now described. For instance, FIG. 12 illustrates an exemplary distributed architecture 1200 for online advertising, which comprises publishers 1202. For purposes of explanation only, publishers 1202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 1200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 1202 is intended to represent any number of types, sizes, sophistication levels, etc. of publishers. In an embodiment, publishers 1202 desire to sell advertisement space on their websites to advertisers 1206 (discussed below).

Architecture 1200 also comprises publisher broker 1204. For purposes of explanation only, only one publisher broker will be discussed herein. However, embodiments of the present invention are not limited to a single publisher broker, as any number of publisher brokers may exist. In an embodiment, publisher broker 1204 is an aggregator of publishers. Specifically, publisher broker 1204 is an entity that represents publishers 1202 with the goal of maximizing ad revenue, ensuring quality ads, etc. Publisher broker 1204 breaks the conflict of interest that is inherent in systems such as Google's AdSense by solely focusing on managing publishers 1202's yield. Publisher broker 1204 allows small and mid-size publishers (such as those that may be represented by publishers 1202) to aggregate in order to drive higher yield for themselves. In an embodiment, publisher broker 1204 maintains a user interface through which it interacts with publishers 1202 and through which it manages publishers 1202's preferences.

In an embodiment, publisher broker 1204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed and what the publisher broker can expect in terms of a payment.

Architecture 1200 also comprises advertisers 1206. For purposes of explanation only, advertisers 1206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 1200.

In an embodiment, each advertiser purchases ad space on websites. For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 1206 is intended to represent any number of types, sizes, sophistication levels, etc. of advertisers. In an embodiment, advertisers 1206 desire to pay money to place ads on publishers 1202's websites.

Architecture 1200 also comprises advertiser broker 1208. For purposes of explanation only, only one advertiser broker will be discussed herein. However, embodiments of the present invention are not limited to a single advertiser broker, as any number of advertiser brokers may exist. In an embodiment, advertiser broker 1208 is an aggregator of advertisers. Specifically, advertiser broker 1208 is an entity that represents advertisers 1206 with the goal of optimizing advertisers 1206's spending and placing monetary values on displaying advertising of a particular format, on a particular website, to a particular audience. In an embodiment, advertiser broker 1208 maintains a user interface through which it interacts with advertisers 1206, and through which it manages advertisers 1206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 1200 also comprises exchange 1212. Exchange 1212 acts as a mediator among publisher broker 1204 and advertiser broker 1208. In an embodiment, exchange 1212 routes traffic and facilitates transactions, e.g., auctions, between publisher broker 1204 and advertiser broker 1208. In an embodiment, exchange 1212 is a server or a set of servers.

To provide minimum standards of conformity, in an embodiment, exchange 1212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 1212 sends all publisher broker requests that match a set of criteria defined by the advertiser broker, along with all relevant data about the request (e.g., the ask and collection symbols provided by the publisher and the exchange itself). In an embodiment, if the advertiser broker has any ads that it would like to have displayed and that meet the ask, it returns those ads, up to the number of ads requested, along with a CPI (cost per impression) bid on each. It is noted that CPM (cost per thousand impressions) and CPI are equivalent pricing models with different acronyms. However, embodiments are not limited to CPI pricing, as other pricing models may be used, e.g., CPC (cost per click), CPA (cost per acquisition), and revenue sharing. Exchange 1212 provides a call back to the winning advertiser broker(s) telling it which ads were displayed, and at what prices.

Architecture 1200 also comprises users 1214. For purposes of explanation only, only one user will be discussed herein. However, embodiments of the present invention are not limited to a single user, as any number of users may exist. Users 1214 request a webpage from publishers 1202. The webpage comprises content and advertisement space, which is filled with advertisement(s) from advertisers 1206.

Using architecture 1200, audience data can be provided to advertisers 1206 either by enriching the publishing property with customer intelligence or by acquiring the data directly from a data broker 1210 on the basis of a licensing fee. For instance, advertiser broker 1208 can choose to pay an estimated monthly per volume amount for each attribute that their advertisers are interested in targeting. This transaction could be done off-line but would need to be registered with exchange 1212 to facilitate data rerouting at request time. Advertiser broker 1208 can base its bids on any targeting attributes provided by data broker 1210.

In an embodiment, when publishers 1202 have an impression that they are willing to sell (with an optional ask), they can provide a URL and any targetable values to exchange 1212. Exchange 1212 passes this data and possible additional user data from data broker 1210 to advertiser broker 1208. In an embodiment, advertiser broker 1208 ranks the bids of advertisers 1206 using any proprietary attributes or techniques that it finds useful. For example, advertiser broker 1208 could choose to run keyword extraction or categorization and use this for targeting. Advertiser broker 1208 would output a CPI ranked list of advertisers (in an embodiment, the number would be equal to the number of ads requested by the publisher). In an embodiment, where multiple advertiser brokers exist, exchange 1212 then ranks all ads across all advertiser brokers and chooses the best one (as measured by CPI). If these ads meet or exceed the publisher ask, then exchange 1212 proxies a display of the ads on the publisher website.

A second-price auction can still be applied to facilitate aggressive bidding. Publishers 1202 can get paid on a CPI basis. In an embodiment, exchange 1212 may be used to gate user information originating from publishers 1202. Publishers 1202 can choose to enrich their property with user data and share this information only with selected advertiser brokers.

Because publishers 1202 are concerned with user satisfaction, they would prefer to have some control over the relevancy of the ads placed on their site. Click-through rate is considered a good measure of relevance and therefore many publishers might want minimum click-through guarantees on the ads. Exchange 1212 allows publishers 1202 to optionally specify a minimum click-through rate that is acceptable. Exchange 1212 monitors advertiser broker 1208 to make sure that if it wins these types of asks, then it is meeting the performance guarantees. In an embodiment, if an advertiser broker consistently provides low click-through rates for publisher asks that require a minimum, exchange 1212 may take punitive measures such as suspension from the system.

Advertiser broker 1208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 1208 could multiply the conversion rate by the per conversion bid of the advertiser. The more information available in each request, the better job advertiser broker 1208 can potentially do in predicting the probability of a click or a conversion.

The entity hosting exchange 1212 has access to all data sources, giving it the power to make partial decisions. To alleviate the concern that exchange 1212 will not be impartial both as hosting body and as a direct participant, in an embodiment, transparency will be built into exchange 1212. In that embodiment, exchange 1212 does not have a way to identify brokers of any kind. Also, in that embodiment, advertiser auction algorithms and advertiser to publisher matching algorithms are standardized and transparent to all exchange participants. In an embodiment, no user identifiable information is sent to advertisers 1206 until the user performs an action. Exchange 1212 passes advertiser broker 1208 only the attribute values. Advertisers 1206 do not see the user identifier. At click-time, however, it is still possible for an advertiser to establish a user identifier and associate the bidding profile with that user. For example, exchange 1212 could require a linear value function, and advertisers 1206 would specify a base bid and a bid increment for each attribute value.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Borders as a publisher has a user requesting the page on the “Lonely Planet Guide to Indonesia” and they would like to show ads on that page. They call exchange 1212 with the page URL and information about the user: “Bought four travel books in the last month,” “Bought a book on Bali in the last month,” and “Has clicked on ads before.”

Given the URL, exchange 1212 extracts keywords (“Bali vacations,” “Indonesia travel,” “exotic vacations,” “beach vacations”) and categories (“travel,” “vacations”), and sends this information to each advertiser broker. Each advertiser runs an auction for the impression. The advertiser broker can choose to ask for aggregate bids from advertisers. For example, Expedia might place an aggregate bid of 24 cents, and after subtracting the licensing fees, their base bid would be equal to 20 cents. Expedia's advertiser broker needs first to subtract all incremental bids and to assign credit to the publisher as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. The publisher was not able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents.

Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

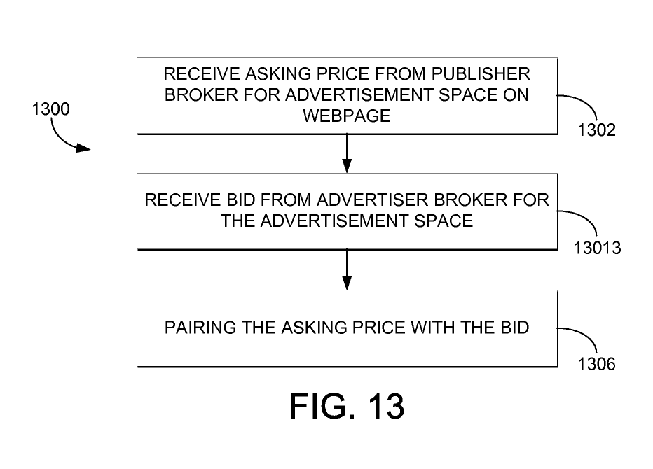

FIG. 13 illustrates a flowchart of the operation of an exchange, according to embodiments of the present invention. Referring to FIG. 13, method 1300 begins with the receipt of an ask from a publisher broker for advertisement space on a webpage (1302). A bid is received from an advertiser broker for the advertisement space (1304). In an embodiment, bids are received from many different advertiser brokers. The ask is paired with one of the bids (1306) and the advertisement space on the webpage is awarded to the winning bidder. As discussed in greater detail above, other information such as user attributes may be attached to the ask, and quality of the bidding advertisers may be examined prior to the advertisement space being awarded.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

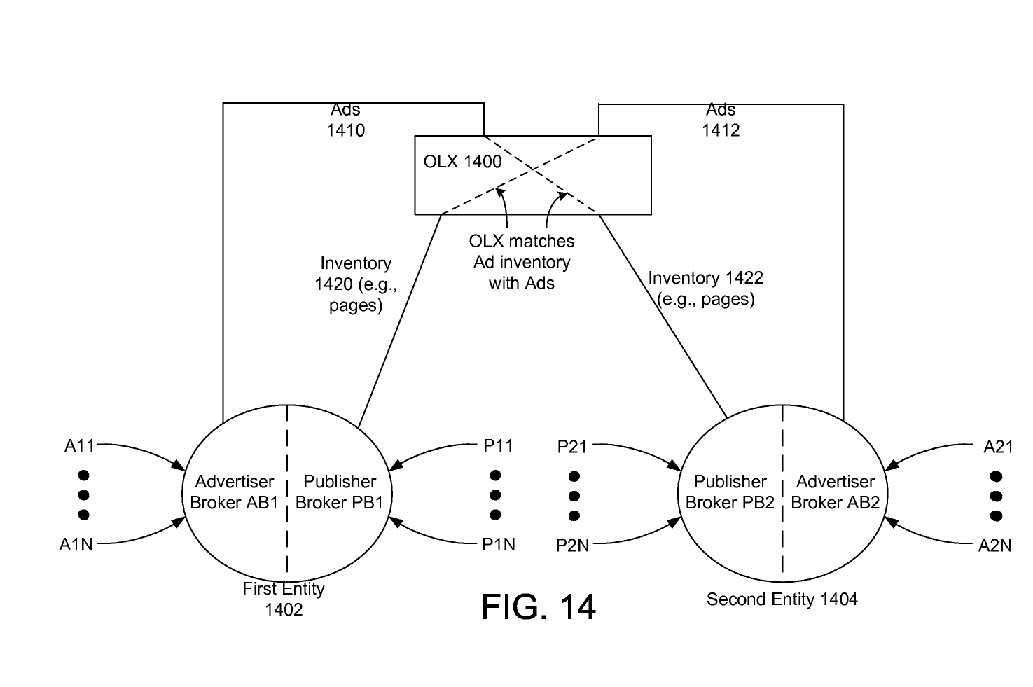

The invention thus can operate in a system that enables broad liquidity over distributed advertising markets, such as the above-described advertising exchange systems. FIG. 14 illustrates a conceptual block diagram of an on-line advertising exchange 1400 provided in accordance with the invention. As shown, a first entity 1402 and a second entity 1404 are subscribers to the services of exchange 1400. First entity 1402 may have an advertiser broker AB1 for brokering advertisements 1410 from a variety of sources A11 thru A1N and a publisher broker PB1 for brokering inventory 1420 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 1404 may have an advertiser broker AB2 for brokering advertisements 1412 from a variety of sources A21 thru A2N and a publisher broker PB2 for brokering inventory 1422 from a variety of publishers P21 thru P2N.

By providing ads 1410 and 1412 to OLX 1400 according to a first communications layer, and by providing inventory 1420 and 1422 to OLX 1400 according to an independent communications layer, OLX 1400 can efficiently match advertisements to available inventory with greater simultaneous knowledge of multiple advertising networks.

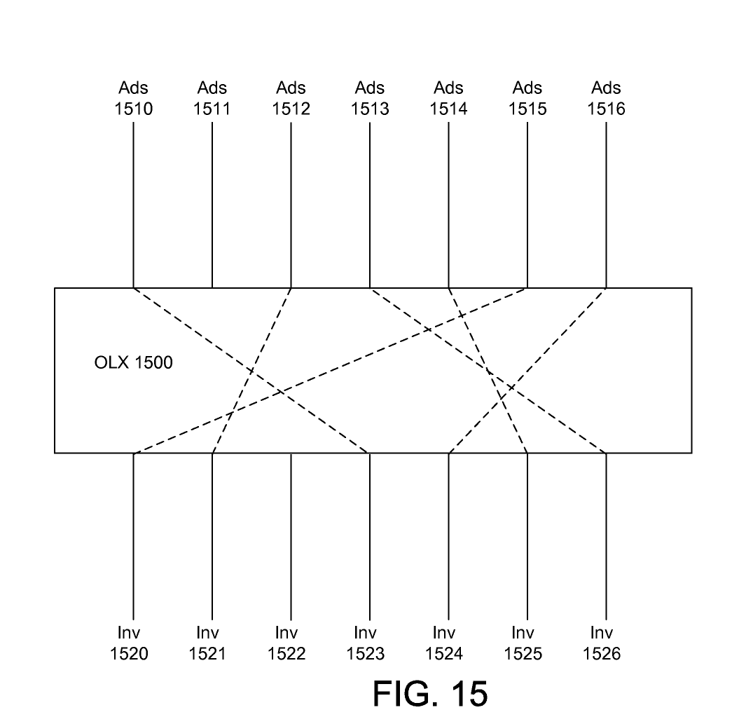

For instance, first entity 1402 might be Microsoft's MSN Web site, and second entity 1404 might be Yahoo's portal Web site. For simplicity, FIG. 14 illustrates only two entities, but advantageously, the invention can also be scaled to accommodate any number of advertising networks, e.g., eBay, Amazon, Google, etc. This is illustrated in FIG. 15 showing an OLX 1500 that accommodates a wide range of advertising 1510, 1511, 1512, 1513, 1514, 1515, 1516, etc. from a wide range of parties, and also accommodates a wide range of inventory 1520, 1521, 1522, 1523, 1524, 1525, 1526, etc. from a wide range of parties. OLX 1500 then makes the best assessment of how to match advertising content with inventory according to a variety of policies (e.g., maximizing ad revenue, maximizing quality of advertising, maximizing conversion rate, etc.). While various non-limiting embodiments of the invention are described in the context of two parties herein, this is for ease of conceptual presentation. It can be appreciated that the invention can be provided for any arbitrary number of advertising entities wishing to join the exchange 1500.

As mentioned, the invention may be implemented in a peer-to-peer architecture, wherein processing performed by the exchange of the invention is shared across multiple participating machines. In such a non-limiting embodiment, each machine participating in the exchange network enabled by the invention can share some of the processing associated with the on-line exchange of the invention.

### Supplemental Characteristic(s) of a Federated Advertising Exchange

In various non-limiting embodiments thus far described, available advertisements are matched to existing inventory by subscribing to the services of an exchange provided in accordance with the invention, and a variety of architectures may be implemented to achieve the functionality of the federated marketplace across disparate advertising networks. In this section, various different kinds of functionality that can be centralized or distributed in connection with operating a federated advertising exchange are now described.

First, the invention should not be considered limited to currently available goods and inventory, but rather broader financial markets for advertising consumption should be considered. For instance, in one non-limiting implementation of an exchange in accordance with the invention, futures or options for advertising products can be brought together as between buyers and sellers.

The online advertising exchange of the invention can thus be implemented as a futures exchange, which provides a marketplace in which to trade derivatives such as futures contracts and options for advertising products. Advertising can thus be thought of as a commodity within certain classes, and can thus be traded similar to grains, currency, short-term interest rates, bonds, etc. Either futures or options can be implemented in such an advertising exchange. A futures contract gives the holder the right and the obligation to buy or sell, which differs from an options contract, which gives the buyer the right, but not the obligation, and the option writer (seller) the obligation, but not the right. In this regard, the more participants in the exchange of the invention, the more pricing information that is available to provide a broad liquid market for advertising benefiting all of the participants.

In exemplary, non-limiting embodiments, the distributed framework for online advertising of the invention enables the specification of personal or private utility functions, i.e., each party can specify respective maximization functions based on different utility functions. Since each party has unique business goals and objectives, a wide variety of objectives may be toggled, or modified in accordance with the invention to specify party utility functions on a per party basis. For instance, as publisher broker, a typical goal is to maximize revenue for the available advertising inventory. But for another publisher broker connected to the exchange, the publisher broker might have 10 ads, but wish to emphasize only 1 particular ad for relevance. Yet another publisher broker might wish to only display “name brand” advertisements, i.e., no advertisements from relatively unknown “mom+pop” establishments, or other small concerns. And so on.

Once each party has specified a complete utility function which maps to the goals and objectives of the party with respect to advertising, this information is received by the exchange. Since initially, different parties' utility functions may be specified according to different vocabularies, the exchange operates to normalize all of the utility functions of the different parties into a common currency. For instance, with respect to advertising, utility functions have typically been defined with respect to such metrics as cost per impression (CPI), cost per conversion (CPC) or cost per acquisition (CPA). Any party can specify a utility function based on any of these metrics, and based on known mappings between metrics, utility functions across different parties can be normalized. Arbitrary metrics, i.e., based on arbitrary variables other than impressions, conversions or acquisitions, can also be defined, and mapped to a common currency by the exchange.

In addition, in order to specify personal utility functions, the invention provides tools that allow entities participating in the exchange to explicitly state their personal utility function. For instance, a florist may sell roses, which have high margins, and carnations, which have low margins. When determining which kinds of keywords to buy, normally, the florist might be interested in 3 different keywords including “flower,” which might be inexpensive due to its widespread applicability, “rose,” which might be expensive due to its high margin target, and “carnation,” which might less expensive because of lower margins. Accordingly, based on anticipated returns, a party might specify a utility function that would select only high margin keywords, e.g., “rose”, as a keyword. For another example, a participant might specify a utility function as a probability of expected clickthrough rate with respect to keywords, in which case a different set of keywords might be optimal.

In this regard, the number of factors that a user can vary with the tools of the present invention to personalize a utility function for advertising are virtually limitless. Also, the factors can be tailored to advertising segments, i.e., banner ads can have different factors for personalization than keywords, which have different facts for personalization than pop-up ads, and so on. Furthermore, rather than require an explicit mathematically defined utility function, the tools of the invention optionally include utility function factors in terms of business goals, e.g., maximizing revenue, preserving brand name, broadest advertising exposure, most socially responsible advertising exposure, most demographically targeted advertising exposure, policies based on clickthrough/impression/conversion/acquisition probabilities, and the like.

Chumming, i.e., the strategy of establishing a trail of scents and edible bits that leads one's quarry to one's boat, can effectively be applied for advertising spaces where it is difficult to target potential customers. Much like the fish in the sea, for such advertising products, it is unknown where the fish are at any given moment, but setting up a wide swath of entry points across a variety of advertising spaces acts to catch at least some fish from wherever they are. In this respect, there a lot of different on-line advertising practices that constitute effective advertising from the standpoint of the advertiser, but as a result of which the user suffers from an experience standpoint because the practices are annoying or non-friendly.

These practices are similar to “spam” practices because the ads are simply not wanted by more than 99.9% of the people that receive them. The only reason they are effective is because a single conversion (i.e., from the 0.1%) results in a large payout, e.g., hundreds of dollars in mortgage fee closing costs. With such advertising, a single customer can justify annoying hundreds or thousands of other potential customers. Thus, in various non-limiting embodiments of the invention, an online advertising exchange operates to penalize such “spam” practices by pricing inventory for those sites where the spam advertisers wish to advertise artificially high. This protects publishers by keeping the quality of the advertising shown on their sites high, but where the publisher elects nonetheless to accept low quality advertising (i.e., advertising with a low clickthrough rate).

Temporal aspects that affect transactions matching advertisements with inventory may also be automatically taken into account. For instance, price curves can be applied over time to inventory so that certain inventory is priced properly in accordance with temporal events affecting the price. For instance, when the Super bowl is playing on television, or immediately following the game, advertising space on ESPN.com may be at a premium since it is likely that a high number of unique visitors will visit ESPN.com during the Super bowl or after. Accordingly, in various non-limiting embodiments, the exchange of the invention operates to normalize pricing for inventory based on temporal pricing variation.

For another example, if Golf.com has an advertisement run on television during the U.S. Open, which announces a deal on golf clubs that can only be redeemed by visiting Golf.com, then it is known that Golf.com will be a high trafficked property temporarily leading to a high conversion rate for other golfing advertisements (such as advertisements for a special on a Golf weekend in Myrtle Beach, etc.). In such example, the television advertisement is the temporal event that dynamically affects the pricing model applied by the exchange of the invention to the advertising inventory available at Golf.com. Accordingly, the exchange knows to temporarily weight the advertising inventory at Golf.com for a pre-defined amount of time following the television advertisement (or according to some other time varying pricing curve). The invention thus contemplates any weighting of pricing models for advertising and/or inventory based on a temporal factors that dynamically affect the value of a given transaction carried out by the advertising exchange of the invention.

Forecasting information can also be taken into account as input when normalizing advertising currency across the available ads and inventory. Forecasting information includes any reliable metric for predicting a future price, and includes, but is not limited to, metrics for monitoring inventory supply and demand curves. In addition, as mentioned earlier, the exchange of the invention operates to normalize advertising currency as between a whole host of publisher brokers and advertiser brokers, and in doing so, creates a market for the exchange of advertising products, including futures market pricing. Forecasting information can thus be applied by the exchange of the invention when setting a price for online advertising futures as well.

Accordingly, the invention provides various architectures for a federated approach to disparate advertising brokers and publisher brokers in contrast to the proprietary closed advertising networks of the past. As additional ad networks join the exchange program of the invention, the power of the market increases because with more information and participants, information about the real-time value of advertising can be made more precise with an increasing view of the larger picture formed by each participant.

As a broader class of secondary markets that can be made in accordance with the invention, speculator contracts can be supported for various advertising markets enabled by the liquidity of the exchange normalization processes for disparate brokers in accordance with the invention. Speculation is typically thought of with respect to the buying, holding, and selling of stocks, bonds, commodities, currencies, collectibles, real estate, derivatives or any valuable financial instrument to profit from fluctuations in its price as opposed to buying it for use or for income via methods such as dividends or interest. The service provided by speculators to a market is primarily that by risking their own capital in the hope of profit, they add liquidity to the market and make it easier for others to offset risk, including those who may be classified as hedgers and arbitrageurs. In this regard, the exchange of the invention, by making advertising resources and products liquid across multiple advertising networks, applies to create a speculation market surrounding the success or failure of advertisements in general, or specific advertisements in particular. The price can be set based on one or more historical, or statistical properties associated with the class of advertising goods associated with the speculation contract. In this respect, speculation contracts can be considered to be similar to futures/options contracts. In one embodiment, the statistics used are median based statistics, which tend to be resistant to tampering, or other artificial influences over a particular market.

The challenge for the speculator with respect to the exchange of the invention is that the speculator can never take delivery of a successful advertisement. More specifically, the speculator does not buy advertising, per se, but rather a bet on the success or failure of the advertising. In this sense, the speculator makes bet on the outcome of advertising. This is akin to betting on the outcome of a movie on opening weekend based on an advertising strategy prior to any audience viewing the movie. If the movie does well, then the advertising has worked effectively. If the movie dies an obscure death, then the advertising did not work effectively.

Another illustrative example is provided with reference to the company that sells the Tickle me Elmo doll. In this regard, from holiday season to holiday season, the company doesn't know if the latest Tickle me Elmo doll will be a big hit with consumers or not. The company doesn't know what other competing market forces will help or inhibit its sales, and simply does not know whether pay out for the Tickle me Elmo doll will be proportional to or outweigh the advertising support given to the launch of the product. However, a speculator might know that a certain competitor that had previously announced their launch of a Giggling Oscar doll has lost all of its inventory due to a pipe bursting in its main storage facility thereby ruining, e.g., shorting out, 97% of the planned inventory. In such a case, the speculator might guess that the Tickle me Elmo doll will perform better than expected due to the elimination of the competitive market force from the Giggling Oscar doll, and buy a speculation contract betting on the advertising support for the Tickle me Elmo doll.

In this regard, any type of competitive market knowledge can form the basis for a speculator contract. For instance, one could bet on whether Britney Spears will receive a lot of hits in any given day. Thus, the number of different micro-markets that are enabled by the exchange of the invention are considered virtually limitless.

Yet another form of advertising/spend product that can be defined in accordance with the invention is an insurance product. Like options and futures contracts, insurance contracts depend on what might happen in the future. For instance, an advertiser may agree to purchase advertising at a price of $1/Elmo advertisement conversion from a given supplier for a fixed period of time (e.g., 1 year) as long as the price for a given class of inventory never goes over $2/Elmo advertisement conversion. Such a transaction can be structured as an insurance contract that the price will never exceed $2/Elmo ad conversion. In such a case, the buyer is willing to pay a premium for the guarantee that the price will stay reasonable for a given time period.

The invention may also be implemented in a peer-to-peer architecture, wherein processing performed by the exchange of the invention is shared across multiple participating machines. In such a non-limiting embodiment, each machine participating in the exchange network enabled by the invention can share some of the processing associated with the on-line federated advertising exchange of the invention.

While exemplary embodiments of advertising platform software may be described herein with respect to Adcenter, it can be appreciated that the use of Adcenter is for illustrative purposes only, and any advertising platform software may be utilized.

In further non-limiting embodiments of the invention, the exchange operates to perform semi-automatic conversion of catalog and margins information to an advertisement portfolio. Such conversion helps enable semi-automatic bidding processes carried out by the exchange based on the portfolio that is produced automatically from current catalog/margins conditions.

In other non-limiting embodiments of the invention, an advertising broker infrastructure is enables that allows a subset of traffic (e.g., 20%) to be cordoned off according to simulation/design experiments to determine what would happen if certain tariffs were applied to the transactions. If the effect of the tariff is onerous, the company can avoid making the costly error, but if however, the traffic is insensitive to the tariff, then the company has an opportunity for additional revenue. Such strategies and experiments can be tested against larger tactical objectives such as maximizing revenue. The invention thus allows fuzzy auto-experimentation based on modification of certain parameters prior to implementing the changes.

Thus, as described, a variety of auctions for advertising or niche goods can be supported in a peer to peer implementation of the online advertising exchange of the invention. In addition, such OLX auctions can be combined with insurance statistics regarding buyers or sellers. For instance, third party escrow agencies could act to distribute fraud detection in such circumstances, or otherwise mitigate auction fraud.

As mentioned, all of the logic of a standalone or centralized online advertising exchange implementation in accordance with the invention can be implemented in a distributed client side application. Thus, any advertisers and publishers with inventory have a client side application that performs according to a local utility function, such as maximizing return on investment, or the like. In this regard, each advertising network is provisioned with an API for communicating information as needed across client peers, and operates on both the seller and the buyer side independently to avoid conflict of interest. The client side application, for instance, operates to monitor inventory, margins for the inventory, opportunity costs, etc. while at the same time operating to maximize revenue for advertising.

For example, it may be known via back office logic that fish goes bad in 2 days. Accordingly, any RFP on the buy side should take this into account to maximize return on investment for fish. The same can be true for advertising. For instance, holiday based advertising may be most relevant during the actual holiday. In this regard, the RFP need not be consumed through the online advertising exchange, but rather can be integrated into the supply chain. For instance, sales can be forecast, and such information can be pushed into the supply chain for the particular goods. For instance, an enterprise resource planning (ERP) ad system can be used to achieve this, in effect integrating the exchange of the invention into the supply chain.

In other non-limiting embodiments, the online advertising exchange of the invention gives a safe way of leaving trade barriers between specific parties—similarly to the way that countries erect trade barriers between one another. The invention thus introduces the notion of an advertising import/export tax. Since both sides of a transaction may be subject to import/export tax, the exchange of the invention operates to automatically normalize for such taxes in purchase price, thereby normalizing deficits with respect to one another. As a result, the invention operates to localize business in a global marketplace, even where a party is only an exporter or only an importer, or both.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space for a plurality of advertising entities from disparate advertising networks participating in a federated advertising exchange, comprising:
interfacing by an advertising console instance to a distributed network of advertising console instances, with advertising console instances provided to each of the plurality of advertising entities to collectively form the federated advertising exchange, including:
requesting at least one advertising transaction between at least two advertising entities;
receiving federated marketplace data from the distributed network of advertising console instances in response to the interfacing;
processing the federated marketplace data by the advertising console instance; and
conducting the at least one advertising transaction between at least two advertising entities by the advertising console instance.

2. The method of claim 1, further comprising:
storing the federated marketplace data by the advertising console instance in storage associated with the advertising console instance.

3. The method of claim 1, further comprising:
sharing the federated marketplace data among the plurality of advertising entities allowing each participating advertising console instance access to substantially current advertising marketplace data from the plurality of advertising entities from disparate advertising networks.

4. The method of claim 3, wherein the sharing includes replicating the federated marketplace data from the advertising console instance to the other advertising console instances of the distributed network.

5. The method of claim 3, wherein the sharing includes synchronizing the federated marketplace data of the advertising console instance with the other advertising console instances of the distributed network.

6. The method of claim 1, wherein the processing includes normalizing the federated marketplace data received from the distributed network to a common standard implemented for the federated advertising exchange.

7. The method of claim 1, wherein the processing includes normalizing at least one utility function of a different advertising entity of the distributed network to a common revenue standard implemented for the federated advertising exchange for comparison of utility functions.

8. The method of claim 1, wherein the processing includes processing at least one of an import tax term, an export tax term, or both received from the distributed network.

9. The method of claim 1, wherein the receiving of federated marketplace data includes receiving data about at least one advertising audience for the advertisement space.

10. A method for facilitating transactions for advertisement space for at least two participating advertising entities from disparate advertising networks participating in a federated advertising exchange, comprising:
receiving advertising transaction information by at least one federated advertising exchange server from interfaces provided to participants, for conducting at least one advertising transaction between at least two participating advertising entities from disparate advertising networks in the federated advertising exchange;
storing, by the at least one federated advertising exchange server, the advertising transaction information in at least one advertising transaction datastore that maintains advertising transaction information on behalf of all interfaces provided to participants; and
conducting at least one advertising transaction between at least two advertising entities from disparate advertising networks based on the collective advertising transaction information represented in the at least one advertising transaction datastore.

11. The method of claim 10, further comprising:
retrieving at least some of the collective advertising transaction information represented in the at least one advertising transaction datastore for use in performing the conducting step.

12. The method of claim 10, wherein the receiving includes normalizing the advertising transaction data received to a common standard implemented for the federated advertising exchange.

13. The method of claim 10, wherein the receiving includes normalizing at least one utility function of an advertising entity to a common revenue standard implemented for the federated advertising exchange for comparison of utility functions.

14. The method of claim 10, wherein the conducting includes processing at least one of an import tax term, an export tax term, or both received by the at least one federated advertising exchange server from the at least two advertising entities.

15. The method of claim 10, wherein the receiving of advertising transaction data includes receiving statistical data about the at least one advertising transaction that facilitates the conducting of the at least one advertising transaction.

16. A system to facilitate trading of advertising, comprising:
a publisher instance of an advertising console for interfacing with a federated advertising marketplace and for use by a publisher broker representing at least one publisher, wherein the publisher broker specifies at least one ask for an advertisement space of the at least one publisher via the publisher instance;
an advertiser instance of an advertising console for interfacing with the federated advertising marketplace and for use by an advertiser broker representing at least one advertiser, wherein the advertiser broker manages at least one bid for the advertisement space by the at least one advertiser via the advertiser instance; and
distributed storage for storing information about at least one transaction for the advertisement space conducted in the federated advertising marketplace via the publisher instance and advertiser instance, respectively, wherein the publisher broker and the advertiser broker are advertising entities of disparate advertising networks, and wherein the information of the distributed storage is shared across all participants in the federated advertising marketplace using a publisher instance or advertiser instance of the advertising console.

17. The system of claim 16, wherein the information of the distributed storage is replicated across all participants in the federated advertising marketplace.

18. The system of claim 16, wherein the information of the distributed storage is synchronized across all participants in the federated advertising marketplace.

19. The system of claim 16, wherein the advertiser instance and publisher instance complete transactions in the federated advertising marketplace on behalf of the advertiser broker and publisher instance, respectively.

20. The system of claim 16, wherein the advertiser instance and publisher instance automatically normalize at least one utility function of the advertiser broker or the publisher broker to a common revenue standard implemented for the federated advertising exchange for comparison of utility functions by the advertiser instance and publisher instance.
